(19) United States
(12) Patent Application Publication
(10) Pub. No.: US 2005/0240372 A1
(43) Pub. Date: Oct. 27, 2005

(54) Apparatus and method for event detection

(76) Inventor: John M. Monk, Monument, CO (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/830,726

(22) Filed: Apr. 23, 2004

(51) Int. Cl. G06F 19/00

(52) U.S. Cl. 702/122

(57) ABSTRACT

A system for testing a network comprises a plurality of network test instruments in communication with a central server. The central server configures the plurality of network test instruments for a test and receiving measurement results related to the test. The central server aggregates the measurements from the plurality of network test instruments and initiates a trigger action when a pattern is detected.

### BACKGROUND OF THE INVENTION

The term network test instrument (sometimes referred to herein as test instruments or testers) encompasses a broad range of test instruments, including device testers, protocol analyzers, compliance analyzers, line testers, etc. . . . In the past, such network test instruments were typically stand-alone units that performed pre-programmed tests on a network or device under test. Results are displayed on a monitor that was usually physically attached to the network test instrument, but possibly at a remote location via a network connection. Such tests are well suited to gaining an understanding of the operation of a single network component, such as a router or switch, or network segment over which traffic passes. However, to test multiple components or segments, the tester must connect with each component and segment for which testing is desired.

Modern networks are tending toward an architecture that favors the interconnection of dissimilar networks though the use of gateways and the like. Also the type of traffic over networks is changing to include high bandwidth mission critical traffic such as VoIP (Voice over Internet Protocol). To come to an understanding of the quality of service (QoS) provided by such modern networks, measurements from diverse locations are often needed. It is not enough to verify the data and QoS across a single component; rather, the data stream must be followed from start to finish.

Another area that would benefit from the use measurements and tests conducted at different locations is hacker defense. Hackers typically spoof and otherwise direct attacks from multiple locations. Network test instruments that focus on a single location may not be able to identify an attack based on a data stream through that location, however if multiple streams were accessible, identifying some attacks becomes easier to identify.

No single network test instrument is capable of performing all the necessary measurements needed to monitor emerging networks and traffic. Accordingly, network test instrument manufacturers, such as AGILENT, are creating distributed network testing environments wherein a plurality of network test instruments perform measurements from multiple locations and provide results to a central location. The central location collects the measurements from a plurality of test instruments and formats a display of results on a monitor.

Not surprisingly, the consolidation of measurements from multiple network test instruments has lead to information overload, wherein the user of such systems are presented with too much information limiting their ability to identify problems. Advances in information display methodologies, such as hierarchical displays that facilitate drilling down from abstracted information to the raw data, have lessened the problem. See for example co-pending U.S. patent application Ser. No. 10/225,181 entitled METHOD AND APPARATUS FOR DRILLING TO MEASUREMENT DATA FROM COMMONLY DISPLAYED HETEROGENEOUS MEASUREMENT SOURCES. The '181 application, filed Aug. 22, 2002, is assigned to the assignee of the present application and is incorporated herein by reference.

Another area that designers of test and measurement instruments are trying to improve upon is the automation of responses to identified problems. See for example U.S. Pat. No. 5,621,892 entitled METHOD AND APPARATUS FOR MANAGING ALERTS AND EVENTS IN A NETWORKED COMPUTER SYSTEM, issued Apr. 15, 1997. Also see U.S. patent application Ser. No. 09/835,619 entitled SYSTEM AND METHOD FOR AUTOMATED PREDICTIVE AND SELF-HEALING NETWORK ANALYSIS. The '619 application, filed Apr. 16, 2001, is assigned to the assignees of the present application and is incorporated herein by reference. In known responsive test and measurement systems, the typical mode of operation is to receive alarms from a single instrument or component and respond accordingly. A case in point is the '892 patent in which each alert is associated with a service such as fax, pager and e-mail.

No known solution has been presented that provides for automatic responses to problems identified in distributed network testing environments. The present inventors have identified a need for systems and methods that aggregate data from a plurality of network test instruments, determines if an event or sequence of events of interest has occurred, and implements corrective action when such and event or sequence of events has occurred.

### BRIEF DESCRIPTION OF THE DRAWINGS

An understanding of the present invention can be gained from the following detailed description of the invention, taken in conjunction with the accompanying drawings of which:

FIG. 1 is a block diagram of a network.

FIG. 2 is a block diagram of a distributed test and measurement framework.

FIG. 3 is a block diagram of a collection topography.

FIG. 4 is a block diagram of an example test instrument

FIG. 5 is a flow chart of a method in accordance with a preferred embodiment of the present invention.

FIG. 6 is a flow chart of a method in accordance with a preferred embodiment of the present invention.

FIG. 7 is a screen shot of an agent trigger pattern specification window in accordance with a preferred embodiment of the present invention.

FIG. 8 is a screen shot of an agent trigger pattern specification window in accordance with a preferred embodiment of the present invention.

FIG. 9 is a screen shot of an agent trigger pattern specification window in accordance with a preferred embodiment of the present invention.

FIG. 10 is a screen shot of a server trigger specification window in accordance with a preferred embodiment of the present invention.

### DETAILED DESCRIPTION

Reference will now be made in detail to the present invention, examples of which are illustrated in the accompanying drawings, wherein like reference numerals refer to like elements throughout. The detailed description which follows presents methods that may be embodied by routines and symbolic representations of operations of data bits within a computer readable medium, associated processors, specific and general purpose computing devices configured with network interface cards and the like. A routine is here, and generally, conceived to be a sequence of steps or actions leading to a desired result, and as such, encompasses such terms of art as “program,” “objects,” “functions,” “subroutines,” and “procedures.” These descriptions and representations are the means used by those skilled in the art effectively convey the substance of their work to others skilled in the art.

The methods of the present invention will be described with respect to implementation on a protocol analyzer, but the methods recited herein may operate on a general purpose computer or other network instrument selectively activated or reconfigured by a routine stored in the computer and interface with the necessary signal processing capabilities. More to the point, the methods presented herein are not inherently related to any particular device, rather, various devices may be used with routines in accordance with the teachings herein. Machines that may be adapted to perform the functions of the present invention include those manufactured by such companies as HEWLETT PACKARD, INC., AGILENT TECHNOLOGIES, INC. and TEKTRONIX, INC. as well as other manufacturers of network testing equipment.

With respect to the software described herein, those of ordinary skill in the art will recognize that there exist a variety of platforms and languages for creating software for performing the procedures outlined herein. The preferred embodiment of the present invention can be implemented using any of a number of varieties of C, however, those of ordinary skill in the art also recognize that the choice of the exact platform and language is often dictated by the specifics of the actual system constructed, such that what may work for one type of system may not be efficient on another system. It should also be understood that the routines and calculations describe in this invention are not limited to being executed as software on a computer or DSP (Digital Signal Processor), but can also be implemented in a hardware processor. For example, the routines and calculations could be implemented with HDL (Hardware Design Language) in an ASIC.

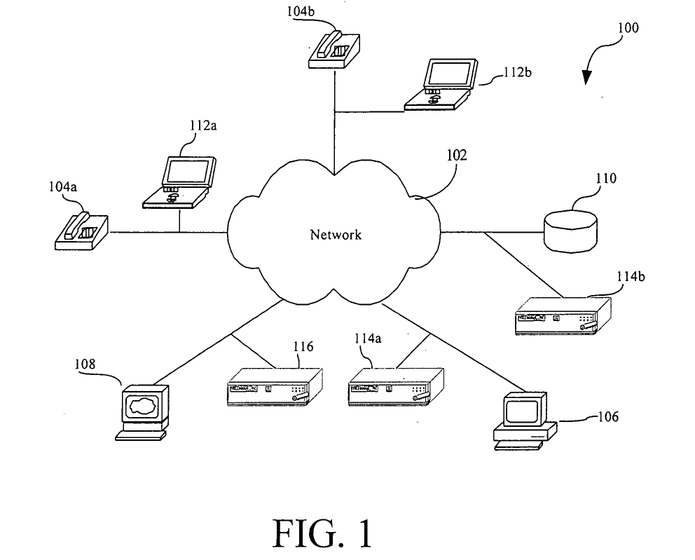

FIG. 1 is a block diagram of a network 100. The network 100 is provided as a non-limiting example of an environment in which the methods and apparatus of the present invention may operate. An IP network 102 connects a variety of devices, including: telecommunication devices 104a and 104b; computer 106; server 108; and database 110. The telecommunications devices 104a and 104b can be Voice over Internet Protocol (VoIP) enabled devices or regular circuit switched devices connected through gateways (not shown). The server 108 can provide any of a variety of services including, for example: FTP, HTTP, SMTP, etc. . . .

A variety of test instruments may be deployed to monitor the various connections and the health of the network. The test instruments typically comprise protocol analyzers and Remote Monitoring (RMON) devices. By way of example, AGILENT protocol analyzers can perform various types of single segment measurements, including, but not limited to Telephony Network Analyzers (TNAs), Protocol Vitals, RTP Statistics, etc. TNA measurement running on a protocol analyzer 112a and 112b provide diagnostics of VoIP connections, such as those associated with the telecommunications devices 104a and 104b. Protocol analyzers 114a and 114b provide general diagnostics of the traffic over network interconnections, such as the interconnections between computer 106, the server 108 and the database server 110. An RMON device 116 operates in accordance with a standard monitoring specification that enables various network monitors and console systems to exchange network-monitoring data. In general, RMON provides network administrators with more freedom in selecting network-monitoring probes and consoles with features that meet their particular networking needs.

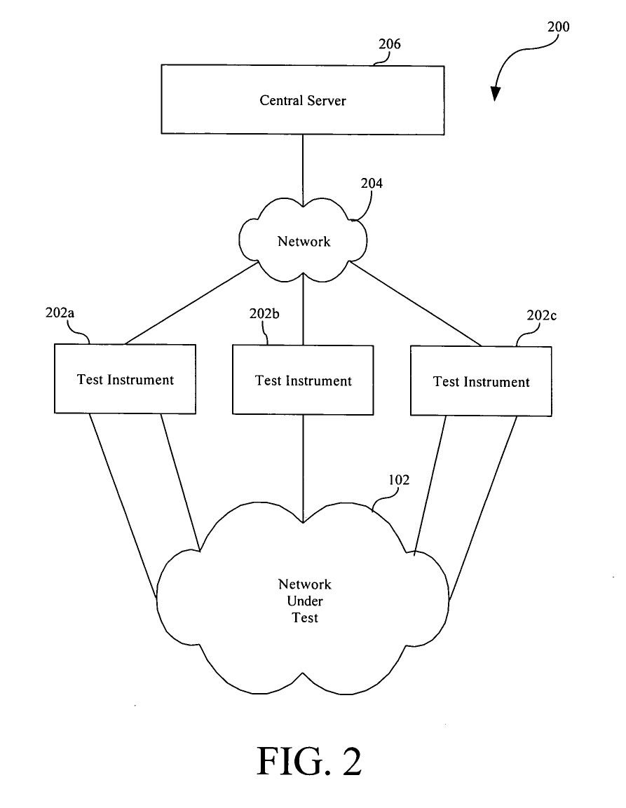

FIG. 2 is a block diagram of a distributed test and measurement framework 200 in which at least one central server 206 is connected to a series of test instruments 202n (202a, 202b and 202c being shown) for testing a network under test 102. Network test instruments, including the AGILENT protocol analyzers and most RMON device, may be configured to interact with a central console, such as the PC 106. A network 204 interconnects the at least one central server 206 with the test instrument 202n. The relationship between the least one central server 206 and test instruments 202n is a many-to-many. In other words a plurality of central servers 206 can interface with a plurality of test instruments 202n. It is also worth noting that each test instruments 202n, may be configured with multiple connections to the network under test 102. While explained in more detail below, most test instruments may be fitted with a plurality of interfaces, so as to, for example, connect to both sides of a gateway.

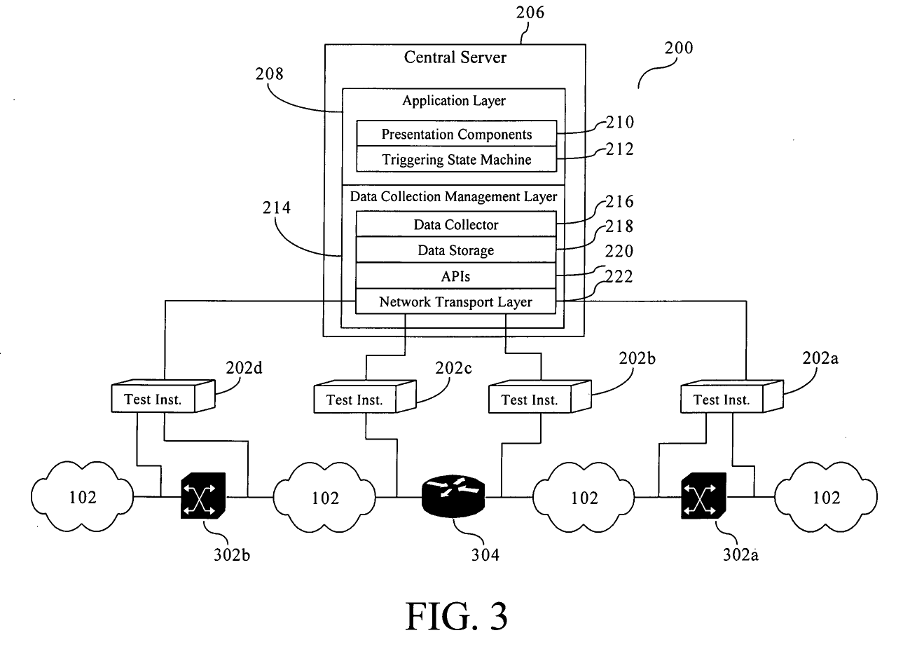

FIG. 3 is a block diagram of a collection topography 200 focusing on the internal configuration of the central server 206. Segments of network 102 are interconnected by, for example, switches 302n and a routers 304. In general, it is desirable for test instruments 202n to be associated with interconnection devices such as switches 302n, routers 304 and gateways (not shown). Accordingly, the test instrument 202a, for example an Agilent DNA MX, is connected via an ATM and Gigabit Ethernet connections to the switch 302a, which may be an ATM switch. The test instruments 202b and 202c, for example Agilent DNA MXs, are connected to routers 304b and 304c via, for example, OC12 connections. Finally, the test instrument 202d, for example an Agilent DNA MX, is connected via ATM and 10/100 Ethernet connections to the switch 302b, which may be an ATM switch.

Each of the test instruments 202n are connected to a central console 206, typically via the network 102. It may be preferable to provide individual direct connections or even a separate intermediate network dedicated to the test instruments 202n and the at least one central server 206. The central server 206 is configured with software, such as the Agilent Network Troubleshooting Center, that receives and displays test and measurement results from the test instruments 202n. In accordance with an embodiment of the present invention, the central server 206 is configured to receive test and measurement results from the test instruments 202n, aggregate the results, compare the results to a trigger condition, and trigger a response when the trigger condition is present. In perhaps the preferred embodiment, and as discussed herein, the central server is provided with a state machine to implement the present invention. It is to be noted that other software constructs can be used to implement the present invention, the state machine being but one example that benefits from being generally understood by those of ordinary skill in the art.

In accordance with at least one embodiment, the software has at least an application layer 208 and a data collection management layer 214. The application layer 208 comprises presentation components 210, including reporting and graphic routines along with a triggering state machine 212. The presentation components 210 being generally understood by those of ordinary skill in the art, further discussion thereof will be generally dispensed with. The triggering state machine 212 manages triggers that are activated based on the occurrence of a distributed event or sequence of events as detected by the test instruments 202n. One suitable embodiment of a triggering state machine 212 will be discussed herein below.

The data collection layer 214 comprises a data collector 216; data storage 218; application programming interfaces (APIs) 220 for communication with the test instruments 202n and a network transportation layer 222 (such as HTTP). The data collection layer 214 is responsible for interacting with the distributed test instruments and collecting their data. The data storage 218 is responsible for taking the data from the data collection layer 214 and transforming it into a form that can be persisted into a database (not shown). The API's 220 facilitates remote and secure control of the network test instruments 202n. In perhaps the preferred embodiment, the API's 220 are implemented using the XML APIs described in co-ending U.S. patent application Ser. No. 10/224,556 entitled SYSTEM CONTROLLING TEST/MEASUREMENT DEVICES ON A NETWORK USING MARKUP LANGUAGE DOCUMENTS AND METHODS THEREOF filed Aug. 21, 2002 and assigned to the assignee of the present application. U.S. patent application Ser. No. 10/224,556 is incorporated by reference herein.

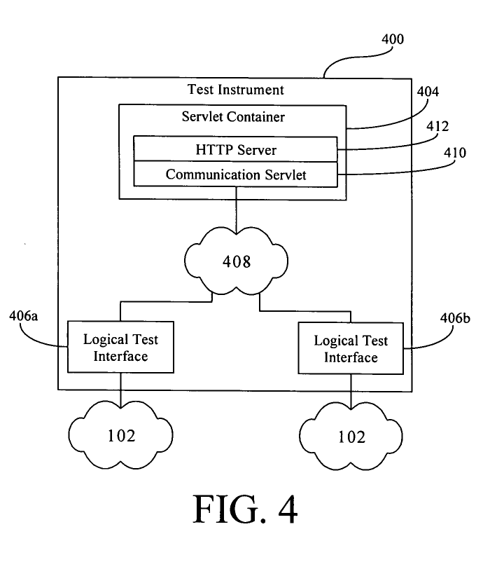

FIG. 4 is a block diagram of an example test instrument 400. The test instrument 400, as shown in FIG. 4, is based on the Agilent Network Analyzer, however those of ordinary skill in the art will recognize that any test instrument architecture suitable for inclusion in a system in accordance with the present invention may be utilized. The test instrument is configured to interface to a plurality of connections on the network under test 102. Internally, the test instrument 400 can, for purposes of explaining the present invention, be thought of as comprising a servlet container 404 interconnected to a plurality of logical test instrument interfaces 406n via an internal network 408 (such as an IP network).

The servlet container 404 generally comprises a collection agent communication servlet 410 and an HTTP server 412. The HTTP server 412 communicates with the data collection management layer 214 in the central server 206 using, by way of example, XML documents as described in co-pending U.S. patent application Ser. No. 10/224,556. The servlet 404 may be, but is not necessarily, physically separate from its corresponding logical test instrument interfaces 406n.

Each logical test instrument interface 406n generally comprises network transport APIs; XML APIs; test instrument applications; and acquisition hardware, such as Agilent's Line Interface Modules (LIMs). In some instances, a logical test instrument interface 406n will comprise a conventional network test instrument configured to communicate with the servlet 404. Such a configuration is more fully explored in co-pending U.S. patent application Ser. No. 10/224,556.

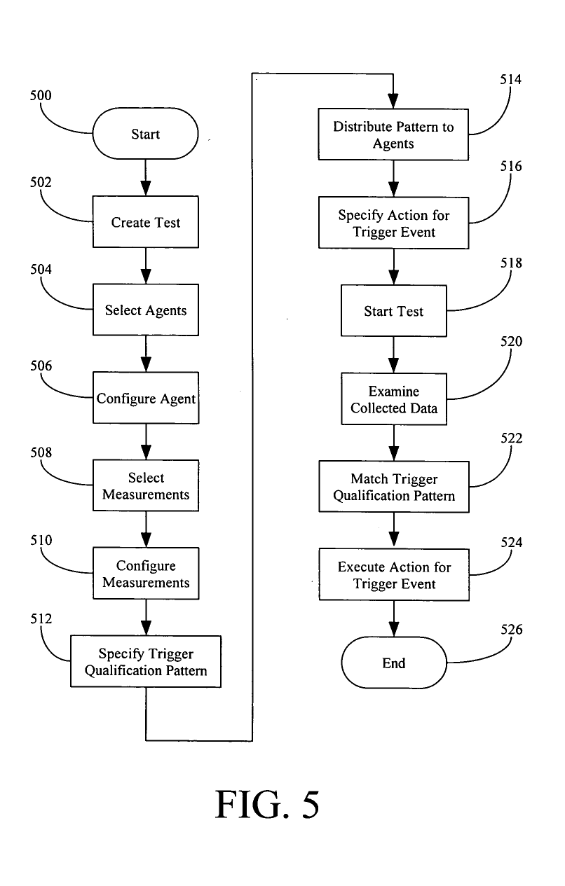

FIG. 5 is a flow chart of a method in accordance with a preferred embodiment of the present invention. The method starts in step 502 with the creation of a test. In general a test comprises a set of one or more measurements from one or more test instruments. In conjunction therewith a trigger event based on the measurements is defined. By way of example, a test can be created that facilitates identification of a traditional SYN denial of service attack. In such an attack, an unusually high number of SYN* requests are directed toward a particular IP address. Further, the SYN* requests typically come from multiple network segments. Thus, an appropriate test would trigger when the aggregate number of SYN* requests, as detected by multiple test instruments, directed toward a particular IP address exceeds a certain threshold.

Next in step 504, the test instruments to be used in the test are selected. This can be as many or as few as desired by the user. In step 506, the selected test instrument's physical interfaces are configured pursuant to their operating software. In step 508, the desired measurements are selected and subsequently configured in step 510, once again pursuant to the operating software on each particular test instrument.

In step 512, a trigger qualification pattern is specified. A trigger qualification pattern is used to instruct the test instrument which measurements to forward to the assigned central server. This allows the user to reduce measurement traffic to only those measurements of interest. Continuing with the SYN* attack test, the user could specify that only SYN* directed at a specified IP address, or range of addresses, are to be considered. In some respects the trigger qualification pattern acts as a filter.

In step 514, the trigger qualification pattern is distributed to agents selected in step 504. This can be carried out using the XML APIs 220 as described in co-ending U.S. patent application Ser. No. 10/224,556.

In step 516, an action is specified for execution when the central server identifies a trigger condition. The action may preferably be in the form of an executable, batch, script or macro file. For example, the action could comprise opening an instance of a network analyzer on a screen and drilling down to the relevant measurements on an identified test instrument. By way of another example, the action could comprise the setting of a second test with a second trigger and subsequent action. In yet another example, the action could comprise storing test and measurement results in the data storage 218 (see FIG. 3) for a pre-defined (or open) period of time. Additionally, the action can comprise sending an SNMP trap to an OSS system. It is to be recognized that a variety of possible actions exist and that any one or any combination of actions can be taken in response to the detection of a trigger condition. The spectrum of possible actions is largely outside the scope of the present invention such that further discussion thereof will be limited.

In step 518, the test is started. Thereafter, in step 520, the date relayed by the test instruments selected in step 504 are collected and aggregated, for example using the data collector 216 and data storage 218 facilities of the central server 206 (see FIG. 2). In the simplest form, the aggregation comprises adding a value associated with the data, e.g. the number of SYN* requests received. Next in step 522, the data is analyzed to determine if a trigger condition exists. In the simplest form such analysis comprises comparing the combined value calculated in step 520 to a threshold value. If a trigger condition exists, e.g. the number of filtered SYN* requests exceed the threshold, the action specified in step 516 is undertaken.

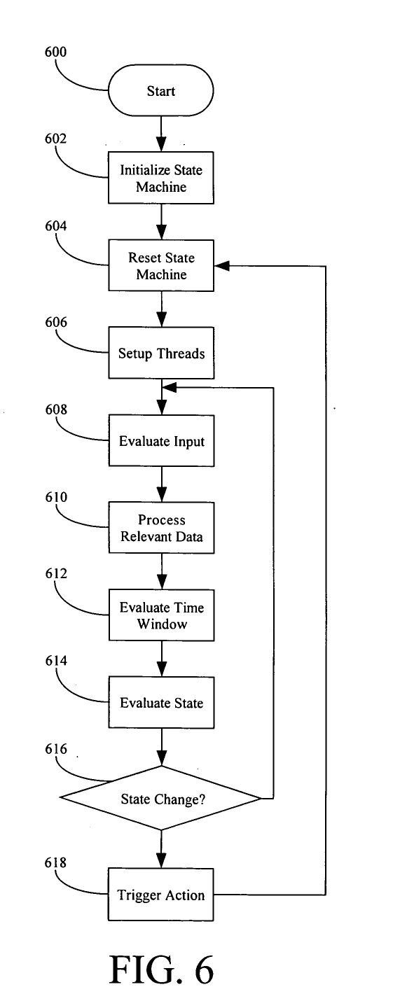

FIG. 6 is a flow chart of a method in accordance with a preferred embodiment of the present invention. Specifically, FIG. 6 is a flow chart of the operation of the triggering state machine 212 in the central server 206, as seen in FIG. 2, in accordance with a preferred embodiment of the present invention. The method starts in step 602 with the initialization of the state machine. Next in step 604, the state machine is reset. In step 606, the necessary threads used by the state machine are set up. In general one thread is devoted to each trigger managed by the central server 206. As is known, threading is a form of parallel processing that facilitates the execution of multiple processes in a seemingly coinciding manner. In accordance with the present embodiment, the use of threads by the state machine allows multiple distinct triggers to be defined and the processes devoted thereto to be run in parallel. This permits multiple tests to be managed by the central server, each having their own trigger definition and action.

In step 608, the input from each test instrument is evaluated to ensure applicability to the current test. For example the headers of packets are checked for the correct content. Next in step 610, the input that is deemed relevant is processed and combined with existing data, for example a packet count is increased. In step 612, a time window is evaluated. In many tests, the time within which tested actions occurs is important. In the prior example of analyzing the SYN* requests received, the time period in which the requests are received is useful in identifying a denial of service attack. Accordingly, time windows may be defined and used to reset any applicable counters. Optionally, when a time window is exceeded without a state change the method may return to step 604 and the state machine is reset. The time period can also be defined to be rolling, with counts being deleted as the time window moves past e.g. the count only reflect SYN* requests received in the last hour.

In step 614, the state of the state machine is evaluated and changed if the state change criteria are meet. In general the state will change upon the identification of a trigger event. For example, the packet count reaches a threshold within the defined time window. Next in step 616, a check is made to determine if the state has changed. If the state has changed, the specified action is executed in step 618. Thereafter, the method returns to step 604 and the state machine is reset. If the state is not changed, the method returns to step 608 for further evaluation. Those of ordinary skill in the art will recognize that the forgoing description of a state machine is not exact and has been simplified to allow for a linear explanation. In perhaps the preferred embodiments, the evaluation of the state and the triggering (steps 614 and 616) are performed in parallel with the date intake and analysis (steps 608 through 612).

Table 1 contains pseudocode describing the operation of a trigger state machine in accordance with a preferred embodiment of the present invention. It is important to note that the pseudocode is within the context of a single thread of operation; there may be multiple threads in the trigger state machine to correspond with multiple tests that are managed by the central server.

TABLE 1
TriggerStateMachine::begin() {

Iterate over headers collected from the distributed test instruments and process them in

parallel
}
TriggerStateMachine::processHeader(newheader, headerProcessObject) {

Give the header to a process objects and delegate the evaluation work to the process object

}
headerProcessObject::evaluate(newHeader) {

Compare the new header with the target header
If it is a match, give the header to the trigger state machine to update its counts

}
TriggerStateMachine::updateCount(newHeader) {

Strip out relevant information
Update counts for agent
Evaluate the overall trigger state

}
StateEvaluation::run() {

While in a non triggered state
Check if the required agents have sent events
Compare events against time window
Stay in the current state or move to a new state or trigger or clear counts and reset state

}
TriggerStateMachine::trigger() {

Perform desired action
Start Remote Troubleshooting or Email notification or Send SNMP trap or other arbitrary

action
}

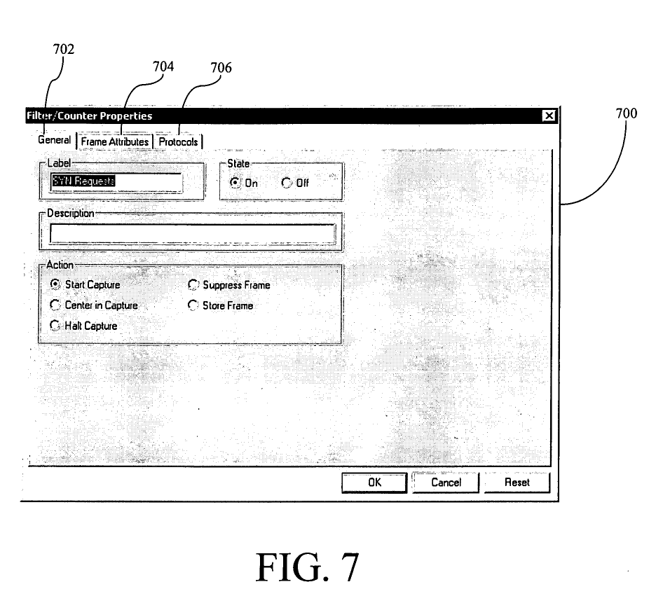

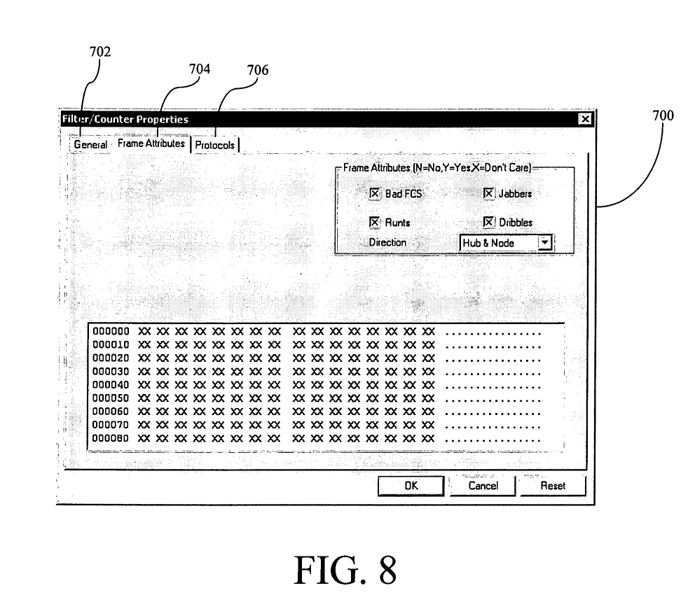

FIGS. 7 through 9 are screen shots of agent trigger pattern specification window 700 in accordance with a preferred embodiment of the present invention. The windows shown in FIGS. 7 through 8 facilitate the creation of a filter in an AGILENT Network Analyzer that causes the test instrument to forward, to a central server, items of interest. Those of ordinary skill in the art will recognize that the windows shown in FIGS. 7 though 8 are but one of many ways that such filters can be set up and configured, the shown screens only being put forth to provide a complete disclosure. Further, test instruments other than the AGILENT Network Analyzer may be used with systems and methods in accordance with the present invention. In general any protocol analyzer may be used so long as it can be configured (preferably remotely) to provide items of interest to a central server, including for example another protocol analyzer.

In some test instruments, users can control the logging period by defining start and stop trigger events. Any number of triggers can be defined. Examples of triggers include: date and time; occurrence of a specified message or parameter value in a message; event (e.g., CRC error); elapsed time from start trigger; repeatable start and stop triggers. Further, some test instruments allow the user to define filters that control the type and amount of data logged (and in accordance with a preferred embodiment of the present invention, communicated to at least one central server). Generally, filters accept or reject messages based upon values within messages (e.g., message types or parameters within messages). Filters can be logically combined using AND/OR.

In FIG. 7, the General Attributes of the filter are configured in a first tab 702 of the window 700. In this case, the filter is given the title “SYN Requests.” Further, an action of “capture” is selected for packets that meet the criteria associated with the filter. Finally, the filter is turned “ON.”

In FIG. 8, the frame attributes of the filter are configured in a second tab 704 of the window 700. Up to 16 Ethernet filters are also available. The filters are logically OR'd together and can filter on the IP address, frame attribute such as good frames, bad Frame Check Sequence “FCS” frames, runts, jabbers and dribbles. A bad FCS can be any number of things but generally refers to a number of valid size frames with Frame Check Sequence (FCS) errors but no framing errors. A runt is a frame smaller than the minimum IEEE 802.3 frame size (64 bytes for Ethernet), and with a bad CRC. A jabber is a frame longer than 1518 octets (excluding framing bits, but including FCS octets), which does not end with an even number of octets (alignment error) or has a bad FCS error. A dribble bit error indicates that a frame is slightly too long. In the example shown in FIG. 8, the user can specify a pattern to look for in the actual data in the frame. This would typically comprise the setting of a data field in the header of a packet in the frame.

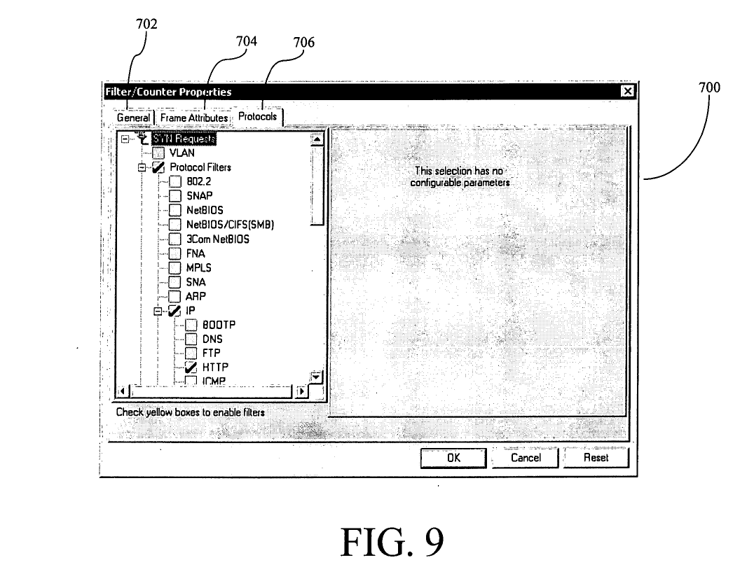

FIG. 9 shows the protocols being identified in a third tab 706 in the window 700. In this case, http traffic over IP being selected.

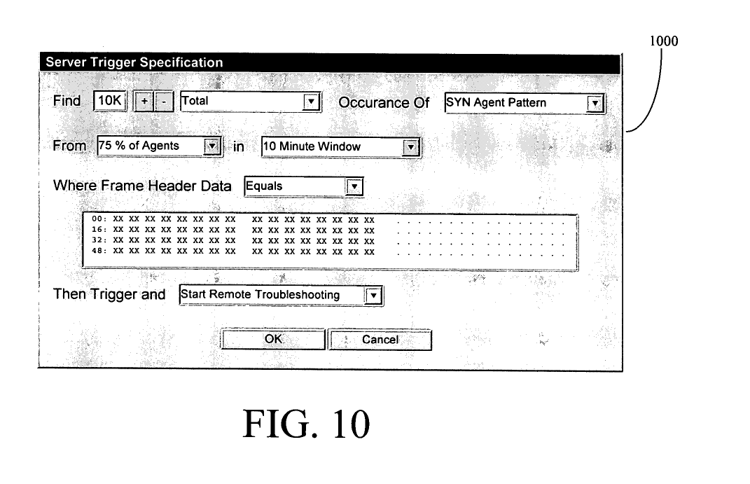

FIG. 10 is a screen shot of a server trigger specification window 1000 and trigger action specification in accordance with a preferred embodiment of the present invention. The window shown in FIG. 10 is an example of software that facilitates the configuration of a central server in accordance with a preferred embodiment of the present invention. In general, the central server operates as a state machine such that any event or series of event that could be used to change the state of the state machine could be used to trigger. The window shown in FIG. 10 is but one example of a collection of trigger criteria that can be used in accordance with a preferred embodiment of the present invention

In the example shown in FIG. 10, a trigger is based on a number of occurrences of a certain defined pattern. Further criteria are provided to qualify the occurrences. For example, the presence of the pattern could be required across a certain percentage (in this case 75%) of the agents. Further, as discussed herein above, a time window can be specified (in this case 10 minutes). The frame header data can also be qualified.

In the example shown, each of the data entry fields can accept whatever values the system designer deems necessary. For example, the number of occurrences can be an open-ended value or bounded. The pattern definition drop down menu could include entries such as: custom; IP; HTTP: FTP; Telnet, etc. . . . The pull down after the word “from,” indicating the number or percent of agents from which the occurrence is received could be programmed to list a variety of percents or a fixed value (as in 10 agents). Of course the time window would permit entry of any useable time value. The frame header filter could be set to “equal” (shown) or “not equal.” The pattern in the Pattern Customization Field is set in the usual manner.

An action is defined for the described trigger event in a pull down box. In the example shown, the action is to start remote troubleshooting. In general, this refers to the automatic opening of windows associated with defined network test agents. Other examples of possible trigger actions include: sending a message to a predefined location via a pre-defined path (such as fax, e-mail, or pager); setting a second trigger; stopping or starting a test and the execution of a program, macro or batch file. The possible actions are only limited by the creativity of the designer and the limitations of the hardware and software.

While the described embodiments of the present invention have focused on the use of triggers to detect a denial of service attack, those of ordinary skill in the art will recognize that an almost infinite variety of triggers are possible. By way of another example, in a large, multi segment VoIP deployment, there is a need to ensure the quality of the calls. In general, such a VoIP deployment is broken up into multiple regions. A test can be created for each region, with each region having multiple TNA measurements. For example, a test that covers the “western region” may have a TNA in San Francisco, San Jose, Oakland, and Sacramento. Thus, the VoIP network and the calls therein are monitored across multiple network segments across California. The test itself can be configured in such a way that, for any TNA in the test, if the MOS (Mean Objective Score—a measure of call quality) goes below a certain threshold, or the jitter is greater than some threshold or the number of lost packets goes above some threshold, a trigger event is generated, and an action initiated. Such an action could comprise a remote drill down to the TNA that is detecting the bad VoIP status, or an SNMP alarm sent to an OSS, etc. This type of test the troubleshooter to more quickly ascertain the location and point of transition from good to bad VoIP phone calls.

Although an embodiment of the present invention has been shown and described, it will be appreciated by those skilled in the art that changes may be made in these embodiments without departing from the principles and spirit of the invention, the scope of which is defined in the claims and their equivalents.

1. A system for testing a network comprising:
a plurality of network test instruments;
a central server in communication with the plurality of network test instruments, the central server configuring the plurality of network test instruments for a test and receiving measurement results related to said test, the central server aggregating the measurement results from the plurality of network test instruments and initiating a trigger action when a pattern is detected.

2. A system, as set forth in claim 1, further comprising:
a second network connecting the test instruments to the central server.

3. A system, as set forth in claim 1, wherein the network connects the central server to the plurality of network test instruments.

3. A system, as set forth in claim 1, wherein said central server communicates with the plurality of network test instruments using XML.

4. A system, as set forth in claim 1, wherein the central server is configured to use a state machine.

5. A system, as set forth in claim 1, wherein the trigger action is the configuring of a second test.

6. A system, as set forth in claim 1, wherein the trigger action is the storing of measurement results produced by the test.

7. A system, as set forth in claim 1, wherein the trigger action is to start a remote session on at least one of the network test instruments.

8. A system, as set forth in claim 1, wherein at least one of the network test instruments is a protocol analyzer.

9. A method of testing a network comprising:
obtaining measurements from a plurality of test instrument each of which tests a different segment of the network;
aggregating the measurements; and
triggering an action based upon the aggregated measurements.

10. A method, as set forth in claim 9, further comprising:
configuring the plurality of test devices from a central location.

11. A method, as set forth in claim 9, wherein the step of aggregating comprises determining a number of instances of a certain data pattern output by each test instrument and adding the number of instances from each test instrument.

12. A method, as set forth in claim 9, wherein the step of triggering comprises executing at least one instruction when the aggregated measurements satisfies a predetermined criteria.

13. A method, as set forth in claim 9, wherein the triggering is performed by a state machine.

14. A method, as set forth in claim 9, wherein the step of aggregating comprises aggregating measurements that are output within a pre-defined time window.

15. A method, as set forth in claim 9, wherein the step of triggering an action comprises opening a instance of one of the test instruments on a central monitor.

16. A method, as set forth in claim 9, wherein the step of triggering an action comprises executing a program.

17. A method, as set forth in claim 9, wherein the step of triggering an action comprises storing data from at least one of the test instruments on a storage device.

18. A method, as set forth in claim 9, wherein the step of triggering an action comprises issuing an SMNP trap to an OSS program.

19. A method of testing a network comprising:
determining if a distributed event or series of events have been detected by a plurality of test instruments in a distributed network;
aggregating the frequency of the occurrence of said events ore series of events into a single value;
executing a trigger action with the single value exceed a predetermined level.
